(19) United States
(12) Patent Application Publication
(10) Pub. No.: US 2026/0205971 A1
(43) Pub. Date: Jul. 16, 2026

(54) ON-DEMAND BANDWIDTH PART

(71) Applicant: Samsung Electronics Co., Ltd., Suwon-si (KR)

(72) Inventors: Hongbo Si, Allen, TX (US); Ebrahim MolavianJazi, San Jose, CA (US); Aristides Papasakellariou, Houston, TX (US); Emad Nader Farag, Flanders, NJ (US); Marian Rudolf, Longueuil (CA)

(21) Appl. No.: 19/425,899

(22) Filed: Dec. 18, 2025

Related U.S. Application Data
(60) Provisional application No. 63/745,580, filed on Jan. 15, 2025.

(51) Int. Cl. H04W 56/00; H04W 24/10; H04W 72/0457; H04W 74/0833

(52) U.S. Cl. CPC H04W 56/0015; H04W 24/10; H04W 72/0457; H04W 74/0833

(57) ABSTRACT

Methods and apparatuses for on-demand bandwidth part (BWP). A method includes receiving a synchronization signals and physical broadcast channel (SS/PBCH) block, identifying a bandwidth for a first BWP (iBWP) based on an indication in a physical broadcast channel (PBCH) of the SS/PBCH block, and determining that the bandwidth for the first iBWP is larger than a maximum reception bandwidth of the UE. The method further includes transmitting an uplink request for a second iBWP, receiving a downlink channel in response to the uplink request, and performing transmission or reception based on the second iBWP.

### CROSS-REFERENCE TO RELATED APPLICATIONS AND CLAIM OF PRIORITY

The present application claims priority to U.S. Provisional Patent Application No. 63/745,580, filed on Jan. 15, 2025. The contents of the above-identified patent document is incorporated herein by reference.

### TECHNICAL FIELD

The present disclosure relates generally to wireless communication systems and, more specifically, the present disclosure relates to a method and apparatus for on-demand bandwidth part (BWP).

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to an on-demand BWP in a wireless communication system.

In one embodiment, a user equipment (UE) in a wireless communication system is provided. The UE includes a transceiver configured to receive a synchronization signals and physical broadcast channel (SS/PBCH) block and a processor operably coupled to the transceiver. The processor is configured to identify a bandwidth for a first initial bandwidth part (iBWP) based on an indication in a physical broadcast channel (PBCH) of the SS/PBCH block and determine that the bandwidth for the first iBWP is larger than a maximum reception bandwidth of the UE. The transceiver is further configured to transmit an uplink request for a second iBWP, receive a downlink channel in response to the uplink request, and perform transmission or reception based on the second iBWP.

In another embodiment, a base station (BS) in a wireless communication system is provided. The BS includes a processor configured to determine a first iBWP and a second iBWP and a transceiver operably coupled to the processor. A bandwidth for the second iBWP is smaller than a bandwidth of the first iBWP. The transceiver is configured to transmit a SS/PBCH block. A PBCH of the SS/PBCH block includes an indication of the bandwidth for the first iBWP. The transceiver is further configured to receive an uplink request for the second iBWP, transmit a downlink channel in response to the uplink request, and perform transmission or reception based on the second iBWP.

In yet another embodiment, a method of a UE in a wireless communication system is provided. The method includes receiving a SS/PBCH block, identifying a bandwidth for a first iBWP based on an indication in a PBCH of the SS/PBCH block, and determining that the bandwidth for the first iBWP is larger than a maximum reception bandwidth of the UE. The method further includes transmitting an uplink request for a second iBWP, receiving a downlink channel in response to the uplink request, and performing transmission or reception based on the second iBWP.

Other technical features may be readily apparent to one skilled in the art from the figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to this disclosure;

FIG. 6 illustrates an example of separate initial BWP for devices with reduced capability according to embodiments of the present disclosure;

FIG. 7 illustrates example procedures for on-demand BWP according to embodiments of the present disclosure;

FIG. 8 illustrates an example method performed by a UE with reduced capability to use a separate BWP according to embodiments of the present disclosure; and

FIG. 9 illustrates a method performed by a UE in a wireless communication system according to embodiments of the present disclosure.

### DETAILED DESCRIPTION

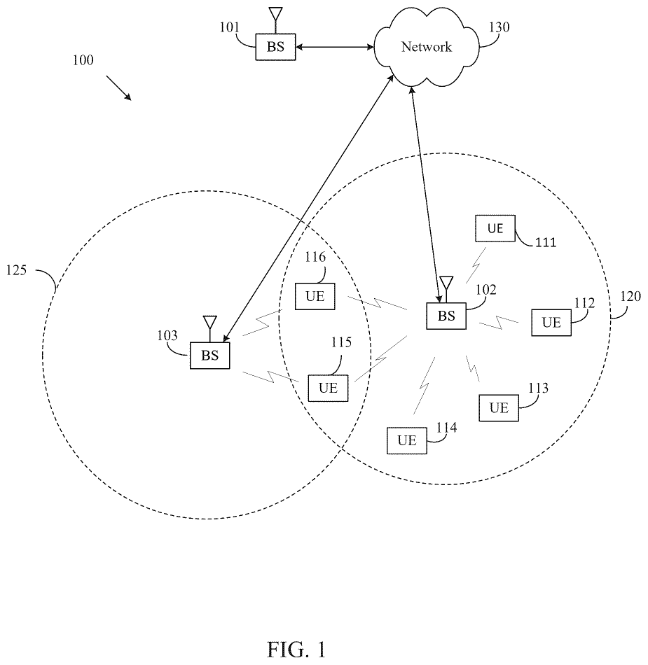

FIGS. 1-9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v18.1.0 , “NR; Physical channels and modulation”; 3GPP TS 38.212 v18.1.0 , “NR; Multiplexing and channel coding”; 3GPP TS 38.213 v18.1.0 , “NR; Physical layer procedures for control”; 3GPP TS 38.214 v18.1.0 , “NR; Physical layer procedures for data”; and 3GPP TS 38.331 v18.1.0 , “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an on-demand BWP in a wireless communication system. In certain embodiments, and one or more of the gNBs 101-103 includes circuitry, programing, or a combination thereof, for supporting an operation for configurations for an on-demand BWP in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

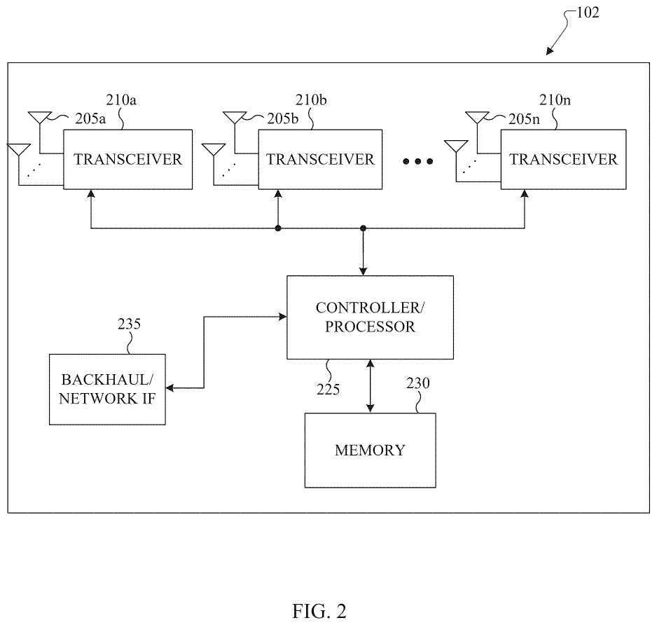

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210 a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting an on-demand BWP in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

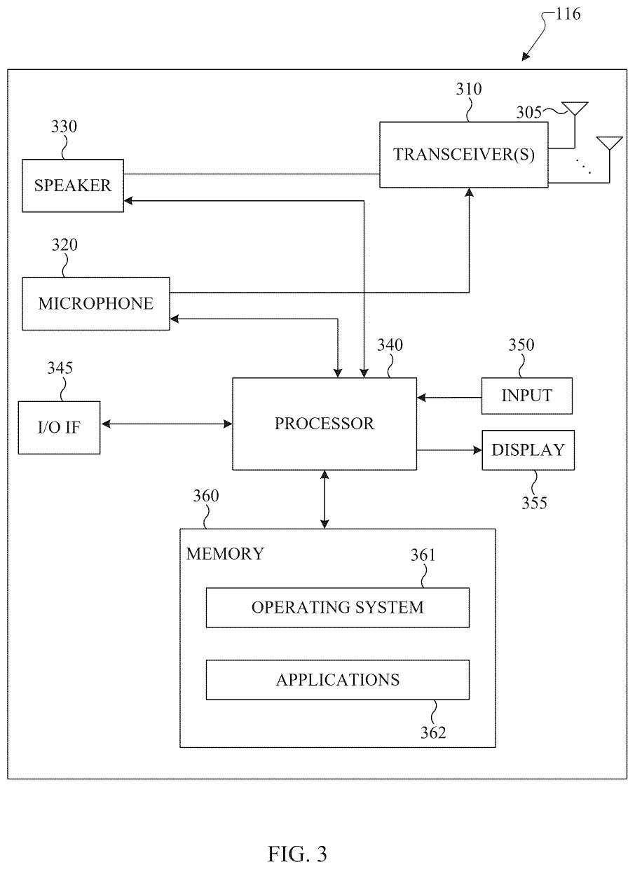

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an on-demand BWP in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

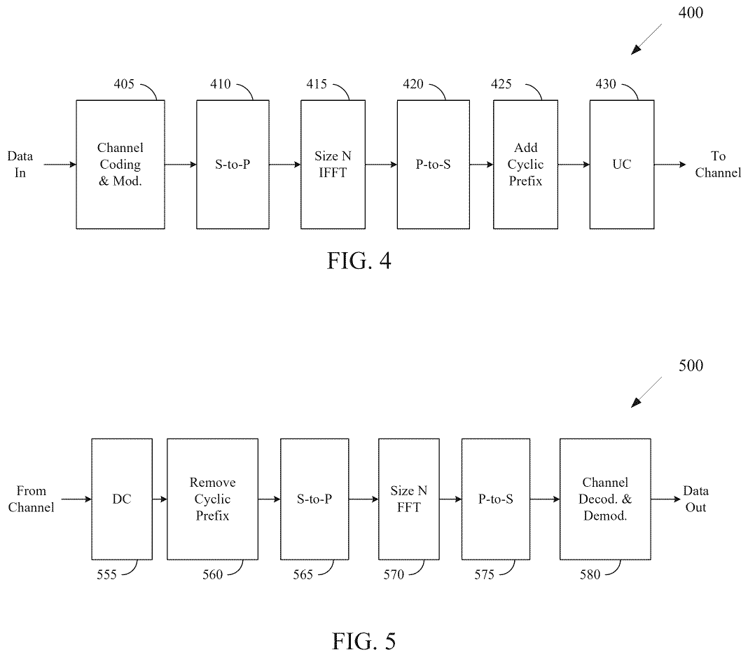

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the receive path 500 can be implemented in a first UE and the transmit path 400 can be implemented in a second UE. In some embodiments, the receive path 500 is configured to an on-demand BWP in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

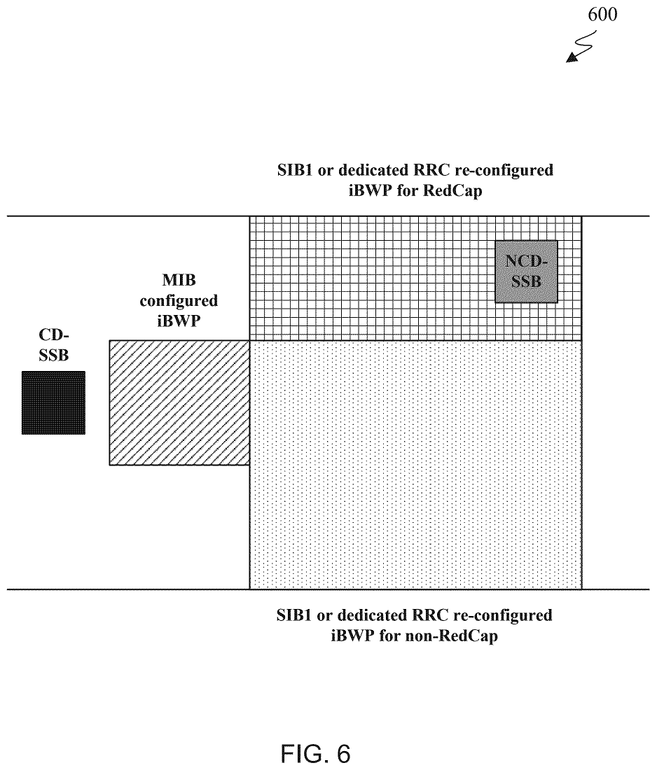

FIG. 6 illustrates an example of separate initial BWP for devices with reduced capability 600 according to embodiments of the present disclosure. The example of separate initial BWP for devices with reduced capability 600 is for illustration only and other embodiments can be used without departing from the scope of the present disclosure.

Various embodiments of the present disclosure recognize that in legacy NR, a cell can be configured with a separate initial bandwidth part (BWP) for devices with reduced capability (e.g., smaller reception bandwidth), wherein the configuration can be provided by a system information block, or a dedicated RRC parameter as shown in FIG. 6. The device with reduced capability can start to use the separately configured initial BWP, after receiving the system information block or the dedicated RRC parameter, however, for initial cell search, the device still uses an initial bandwidth part provided by a configuration carried by a cell defining SS/PBCH block in the cell, which needs to be within the maximum supported bandwidth of the device, and could be a potential restriction to other devices without such maximum supported bandwidth limitation. Also, the separate BWP for devices with reduced capability needs to be always present even when the number of devices with reduced capability is small, which could be a waste of system bandwidth from the perspective of a cell.

Various embodiments of the present disclosure recognize that for new generation of wireless communication system, the supporting of a separate BWP for devices with reduced capability can be redesigned, and the presence of the separate BWP for devices with reduced capability can also be in an on-demand manner. The on-demand BWP, although motivated for devices with reduced capability, can also be applicable for other devices (in such case, the device described in this disclosure would be a regular device without reduced capability). A terminology of BWP can also be referred to as a bandwidth (or a carrier, or a sub-band) for performing downlink and/or uplink transmissions and/or receptions.

Accordingly, embodiments of the present disclosure provide methods and apparatuses for on-demand BWP. Aspects of the present disclosure include: (1) a general procedure for on-demand BWP in both multiple cell and single cell scenarios; (2) a detailed design for the configurations at least related to the on-demand BWP; (3) a method to provide the configurations; (4) a condition for sending the UL request; (5) a timeline for using the on-demand BWP; (6) collaboration with on-demand SIB; and (7) an example UE procedure.

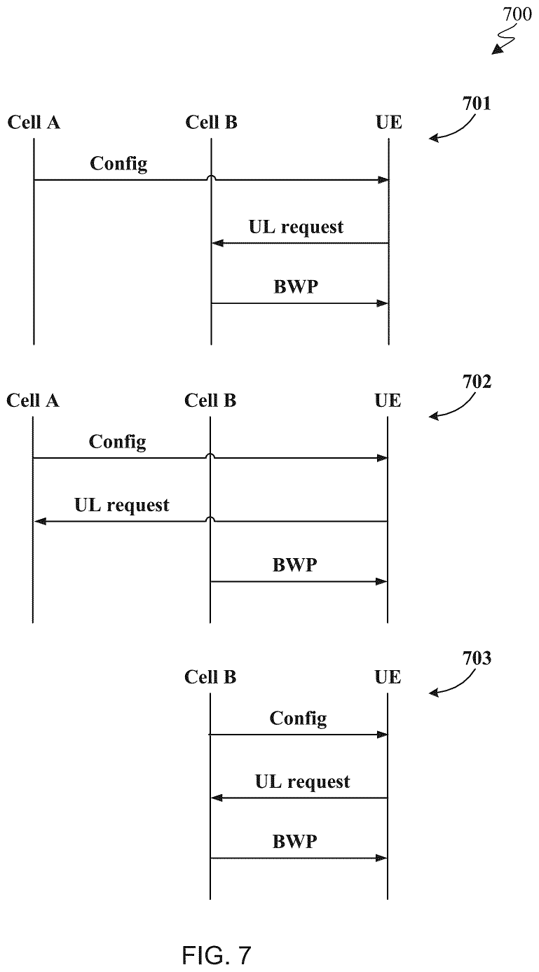

FIG. 7 illustrates example procedures 701-703 for on-demand BWP according to embodiments of the present disclosure. The example procedures 701-703 are for illustration only and other embodiments can be used without departing from the scope of the present disclosure.

For a first example procedure (e.g., 701 in FIG. 7), a UE with reduced capability can acquire a set of configurations from a first cell (e.g., cell A), wherein the first cell does not perform BWP operation for the UE with reduced capability; and the UE with reduced capability may send an uplink request to a second cell (e.g., cell B), wherein the second cell performs the BWP operation for the UE with reduced capability; and the BS associated with the second cell performs the BWP operation for the UE with reduced capability, potentially after sending a response to the UL request to the UE.

For a second example procedure (e.g., 702 in FIG. 7), a UE with reduced capability can acquire a set of configurations from a first cell (e.g., cell A), wherein the first cell does not perform BWP operation for the UE with reduced capability; and the UE with reduced capability may send an uplink request to the first cell; and the BS associated with a second cell (e.g., cell B) performs the BWP operation for the UE with reduced capability, wherein the second cell performs the BWP operation for the UE with reduced capability, potentially after sending a response to the UL request to the UE.

For a third example procedure (e.g., 703 in FIG. 7), a UE with reduced capability can acquire a set of configurations from a cell (e.g., cell B), wherein the cell performs BWP operation for the UE with reduced capability; and the UE with reduced capability may send an uplink request to the cell; and the BS associated with the cell performs the BWP operation for the UE with reduced capability, potentially after sending a response to the UL request to the UE.

For one further implementation of the example procedures, the BWP can be an initial BWP, which could also be referred to as a bandwidth of a CORESET#0, or a bandwidth for operation in RRC_IDLE and/or RRC_INACTIVE mode, or a BWP with index 0, or a BWP for transmitting and/or receiving cell common signal and/or channel, or a BWP with configuration provided by system information (e.g., such as master information block (MIB), or system information block 1 (SIB 1 ), or system information block x (SIBx) where x>1).

For another further implementation of the example procedures, the step of sending a response to the UL request can be absent or implicit.

In one embodiment, the set of configurations, e.g., as illustrated in FIG. 7, can include at least one of the following components in this embodiment.

For one example component, the set of configurations can include information related to a SS/PBCH block or a synchronization signal or a reference signal associated with the second cell (e.g., cell B).
For one sub-example, the physical cell ID of the SS/PBCH block (e.g., PhysCellId) or the synchronization signal or the reference signal.
For another sub-example, the frequency location of the SS/PBCH block or the synchronization signal or the reference signal (e.g., an absolute frequency location such as absoluteFrequencySSB, or a frequency location corresponding to a synchronization raster entry such as a GSCN).
For yet another sub-example, the periodicity of the SS/PBCH block or the synchronization signal or the reference signal (e.g., ssb-PeriodicityServingCell).
For yet another sub-example, the actually transmitted SS/PBCH block indication for the SS/PBCH block or the synchronization signal or the reference signal associated with the cell (e.g., ssb-PositionsInBurst).
For yet another sub-example, the power of the SS/PBCH block or the synchronization signal or the reference signal associated with the cell (e.g., ss-PBCH-BlockPower).
For one further implementation of the sub-examples, the SS/PBCH block can be a cell-defining SS/PBCH block (e.g., with associated SIB1 being present).
For another further implementation of the sub-examples, the SS/PBCH block can be a non-cell-defining SS/PBCH block (e.g., without associated SIB1 being present).
For yet another further implementation of the sub-examples, the SS/PBCH block can be a SS/PBCH block with associated SIB1 being present based on UE's request (e.g., on-demand SIB1).
For yet another further implementation of the sub-examples, the synchronization signal or the reference signal can be provided in an on-demand manner (e.g., on-demand synchronization signal or reference signal).

For another example component, the set of configurations can include information related to a DL carrier (or DL sub-band) where the BWP operation is performed by the second cell (e.g., cell B).
For one sub-example, a frequency band or a frequency band list, for the DL carrier (or DL sub-band).
For another sub-example, a subcarrier spacing of the DL carrier (or DL sub-band).
For yet another sub-example, a starting frequency location of the DL carrier (or DL sub-band) (e.g., absolute frequency value such as absoluteFrequencyPointA or an index of a resource block (RB) with respect to a reference frequency location).
For yet another sub-example, a bandwidth of the DL carrier (or DL sub-band) (e.g., a number of RBs or a number of Hertz (Hz)).
For yet another sub-example, a cyclic prefix of the DL carrier (or DL sub-band).

For yet another example component, the set of configurations can include information related to a UL carrier (or UL sub-band) where the BWP operation is performed by the second cell (e.g., cell B).
For one sub-example, a frequency band or a frequency band list, for the UL carrier.
For another sub-example, a subcarrier spacing of the UL carrier (or UL sub-band).
For yet another sub-example, a starting frequency location of the UL carrier (or UL sub-band) (e.g., absolute frequency value such as absoluteFrequencyPointA or an index of a RB with respect to a reference frequency location or an offset comparing to the DL carrier (or SL sub-band)).
For yet another sub-example, a bandwidth of the UL carrier (or UL sub-band) (e.g., a number of RBs or a number of Hz).
For yet another sub-example, a cyclic prefix of the UL carrier (or UL sub-band).

For yet another example component, the set of configurations can include information related to the BWP.
For one sub-example, a starting frequency location of the BWP (e.g., starting RB index or an absolute frequency value).
For another sub-example, a bandwidth of the BWP (e.g., a number of RBs or a number of Hertz).
For yet another sub-example, a subcarrier spacing of the BWP.
For yet another sub-example, a cyclic prefix of the BWP.
For yet another sub-example, a set of configurations for PDCCH(s) monitored in the BWP, e.g., when the BWP is a DL BWP, such as at least one search space set for the PDCCH(s) and/or at least one control resource set for the PDCCH(s).
For yet another sub-example, a set of configurations for PDSCH(s) scheduled by the PSCCH(s) that are monitored in the BWP, e.g., when the BWP is a DL BWP.
For yet another sub-example, a set of configurations for RACH resources (e.g., time, frequency, spatial, power, or sequence information on a physical random access channel (PRACH)) in the BWP, e.g., when the BWP is an UL BWP.
For one further implementation of the sub-examples, the BWP can be a DL BWP, and sub-examples can be applicable for the DL BWP.
For another further implementation of the sub-examples, the BWP can be an UL BWP, and sub-examples can be applicable for the UL BWP.
For another further implementation of the sub-examples, the set of configurations can be common for the DL BWP and UL BWP, e.g., when the band is a time division duplex (TDD) band.

For yet another example component, the set of configurations can include information related to the UL request, e.g., when the UL request is a random access preamble.
For one sub-example, a PRACH configuration index (e.g., prach-ConfigurationIndex).
For another sub-example, a number of FDMed RO(s) (e.g., msg1-FDM).
For yet another sub-example, a frequency starting location of the RO(s) (e.g., msg1-FrequencyStart).
For yet another sub-example, a configuration for the random access preamble sequence (e.g., zeroCorrelationZoneConfig).
For yet another sub-example, a target reception power of the random access preamble (e.g., preambleReceivedTargetPower).
For yet another sub-example, a maximum number of random access preamble transmission (e.g., preambleTransMax).
For yet another sub-example, a step size for random access preamble power ramping (e.g., powerRampingStep).
For yet another sub-example, a configuration for the time window to monitor random access response(s) (RAR(s)) (e.g., ra-ResponseWindow).
For yet another sub-example, a total number of random access preambles (e.g., totalNumberOfRA-Preambles).
For yet another sub-example, a number of SSB mapped per RO (e.g., ssb-perRACH-OccasionAndCB-PreamblesPerSSB).
For yet another sub-example, a random access contention resolution timer (e.g., ra-ContentionResolutionTimer).
For yet another sub-example, a SSB RSRP threshold (e.g., rsrp-ThresholdSSB).
For yet another sub-example, a PRACH root sequence index (e.g., prach-RootSequenceIndex).
For yet another sub-example, a subcarrier spacing for PRACH (e.g., msg1-SubcarrierSpacing).
For yet another sub-example, a PRACH restricted set configuration (e.g., restrictedSetConfig).
For yet another sub-example, a request period for the UL request (e.g., RequestPeriod).
For yet another sub-example, a preamble start index for the UL request (e.g., ra-PreambleStartIndex).
For yet another sub-example, a preamble association period index for the UL request (e.g., ra-AssociationPeriodIndex).
For yet another sub-example, a RO mask index for the UL request (e.g., ra-ssb-OccasionMaskIndex).
For yet another sub-example, configurations related to repetition of the UL request, at least including a number of repetitions (e.g., RequestResourcesRepetition).
For yet another sub-example, configurations related to a frequency hopping of the UL request, e.g., whether to enable frequency hopping, and/or time period to apply a frequency hopping, and/or a frequency domain step size of the frequency hopping.

For yet another example component, the set of configurations can include information related to the UL request, e.g., when the UL request is a scheduling request.
For one sub-example, a configuration for the time and/or frequency domain resources for a PUCCH carrying the scheduling request.
For another sub-example, a configuration for the time and/or frequency domain resources for a PUSCH carrying the scheduling request.
For yet another sub-example, configurations related to a frequency hopping of the UL request, e.g., whether to enable frequency hopping, and/or time period to apply a frequency hopping, and/or a frequency domain step size of the frequency hopping.

For yet another example component, the set of configurations can include information related to the UL request, e.g., when the UL request is a dedicated signal for requesting the BWP.
For one sub-example, a configuration for the time and/or frequency domain resources mapping the dedicated signal.
For another sub-example, a configuration for the power of the dedicated signal, e.g., transmission power and/or target reception power.
For yet another sub-example, a configuration for parameters for generating the sequence of the dedicated signal.
For yet another sub-example, configurations related to a frequency hopping of the UL request, e.g., whether to enable frequency hopping, and/or time period to apply a frequency hopping, and/or a frequency domain step size of the frequency hopping.

For yet another example component, the set of configurations can include information related to a frequency hopping of the BWP, e.g., whether to enable frequency hopping, and/or time period to apply a frequency hopping, and/or a frequency domain step size of the frequency hopping, and/or a starting frequency location for the frequency hopping, and/or an index for the frequency hopping.

For yet another example component, the set of configurations can include information related to the PBCH payload.
For one sub-example, a common subcarrier spacing (e.g., subCarrierSpacingCommon).
For another sub-example, a subcarrier offset between SSB and common resource grid (e.g., ssb-SubcarrierOffset).
For yet another sub-example, a value of k_{SSB} (e.g., for determining a subcarrier offset between SSB and common resource grid and/or for determining RB-level frequency offset between SSB and CORESET#0).
For yet another sub-example, a value of ā_{Ā+5}.
For yet another sub-example, an indication on cell barring information (e.g., cellBarred).
For yet another sub-example, an indication of configuration for PDCCH associated with the SIB1 (e.g., PDCCH-ConfigSIB1), which may further include controlResourceSetZero and searchSpaceZero.
For one further implementation of the sub-examples, when a UE with reduced capability also receives the SS/PBCH block associated with the second cell (e.g., cell B), the UE can assume the information provided by the set of configurations override the information provided by the SS/PBCH block.
For another further implementation of the sub-examples, when a UE with reduced capability also receives the SS/PBCH block associated with the second cell (e.g., cell B), the UE can assume the information provided by the SS/PBCH block overrides the information provided by the set of configurations.

For yet another example component, the set of configurations can include information related to a timer or a time domain window for the BWP operation.
For one sub-example, a starting time or an offset to a reference timing for the timer or the time domain window.
For another sub-example, a time duration for the timer or the time domain window.

For yet another example component, the set of configurations can include information related to cell barring information for the UE with reduced capability (e.g., cellAccessRelatedInfo or BarringInfo).

For yet another example component, the set of configurations can include information related to a slot format (e.g., tdd-UL-DL-ConfigurationCommon), e.g., when the band is a TDD band.

For yet another example component, the set of configurations can include information related to at least one timing advance, e.g., a timing advance offset (e.g., n-TimingAdvanceOffset).

For yet another example component, the set of configurations can include information related to a channel access for spectrum with shared channel access (e.g., at least one of a channel access mode (e.g., channelAccessMode), and/or parameters for discovery burst transmission window (e.g., discoveryBurstWindowLength), and/or QCL assumption parameter for SS/PBCH block (e.g., ssb-QCL-Assumption), and/or whether to enable interlace based transmission for PUCCH/PUSCH (e.g., useInterlacePUCCH-PUSCH), and/or PRACH root sequence index (e.g., prach-RootSequenceIndex)).

In one embodiment, the set of configurations, e.g., as illustrated in FIG. 7, can be provided to the UE by at least one or combination of the following methods.

In a first method, the set of configurations (or some components in the set of configurations) can be provided by the first cell (e.g., cell A), such as 701 or 702 in FIG. 7, e.g., in a system information block (e.g., SIB0 and/or SIB1 and/or SIBx where x>1) of the first cell, and/or in dedicated RRC parameters of the first cell.

In a second method, the set of configurations (or some components in the set of configurations) can be provided by the second cell (e.g., cell B), e.g., in PBCH of the SS/PBCH block associated with the second cell, and/or in additional PBCH or on-demand PBCH associated with the second cell, and/or system information block (e.g., SIB0 and/or SIB1 and/or SIBx where x>1) associated with the second cell.

In a third method, the set of configurations (or some components in the set of configurations) can be provided by a response to the UL request, wherein the response can be transmitted either from a BS associated with the first cell or a BS associated with the second cell to the UE.

In a fourth method, the set of configurations (or some components in the set of configurations) can be pre-defined or fixed in the specification of system operation, and a UE can acquire the information without explicit indication.

In one embodiment, the UE may send the uplink request when at least one of the following conditions is met.

For one condition, the UE may acquire the set of configurations, e.g., according to examples of this disclosure.

For another condition, the UE may receive a SS/PBCH block, wherein the SS/PBCH block includes a configuration of a bandwidth (e.g., bandwidth for CORESET#0 or bandwidth for BWP) that exceeds the UE's maximum reception bandwidth.

For yet another condition, the UE may perform measurement based on at least one SS/PBCH block, and the UE can select one SS/PBCH block from the at least one SS/PBCH block wherein a measurement result (e.g., RSRP and/or RSRQ) of the one SS/PBCH block is higher than a threshold (e.g., the threshold can be included in the set of configurations or pre-defined), or the UE may select any SS/PBCH block from the at least one SS/PBCH block wherein no measurement result (e.g., RSRP and/or RSRQ) of the at least one SS/PBCH block is higher than a threshold. For one further implementation, the uplink request can be associated with the selected one SS/PBCH block.

For yet another condition, the UE may receive a SS/PBCH block, wherein a frequency location of the SS/PBCH block is provided by the set of configurations.

For yet another condition, the UE may receive a SS/PBCH block, wherein the SS/PBCH block is associated with the cell where the BWP operation is performed.

For yet another condition, the UE may receive a SS/PBCH block, wherein the SS/PBCH block is located on a synchronization raster entry.

For yet another condition, the UE may receive a SS/PBCH block, wherein the SS/PBCH block is a cell defining SS/PBCH block.

For yet another condition, the UE may determine at least one resource for transmitting the UL request is valid or available.

In one embodiment, the UE starts to operate in the BWP based on at least one example timeline in this disclosure.

For one example timeline, after a UE acquires the set of configurations (e.g., according to examples of this disclosure), the UE can operate the BWP according to the set of configurations, such as sending the uplink request and/or monitoring the response to the uplink request in the BWP.

For another example timeline, if a UE acquires the set of configurations (e.g., according to examples of this disclosure), after the UE sends the uplink request, the UE can operate the BWP according to the set of configurations, such as monitoring the response to the uplink request in the BWP.

For yet another example timeline, if a UE acquires the set of configurations (e.g., according to examples of this disclosure), after the UE receives the response to the uplink request, the UE can operate the BWP according to the set of configurations, such as monitoring PDCCH for system information and/or paging in the BWP.

In one embodiment, on-demand BWP and on-demand SIB (e.g., SIB1 or SIBx where x>1) can be supported at the same time for a UE with reduced capability.

For one example, the PDCCH and/or PDSCH of on-demand SIB is received in the on-demand BWP, for the UE with reduced capability.

For another example, there can be a common UL request for on-demand BWP and on-demand SIB, e.g., when a BS receives the common UL request, the BS assumes that the UE is requesting an on-demand BWP wherein the on-demand SIB is received.

For yet another example, there can be separate UL requests for on-demand BWP and on-demand SIB, respectively, e.g., when a BS receives the corresponding UL request, the BS assumes that the UE is requesting an on-demand BWP or an on-demand SIB respectively.
For one sub-example, the time and/or frequency domain resources for the UL request for on-demand BWP and the UL request for on-demand SIB can be different, e.g., not overlapping in the time and/or frequency domain.
For another sub-example, the preamble sequences for UL request for on-demand BWP and the UL request for on-demand SIB can be different.
For yet another sub-example, the configurations for the UL request for on-demand BWP and the UL request for on-demand SIB can be separate.

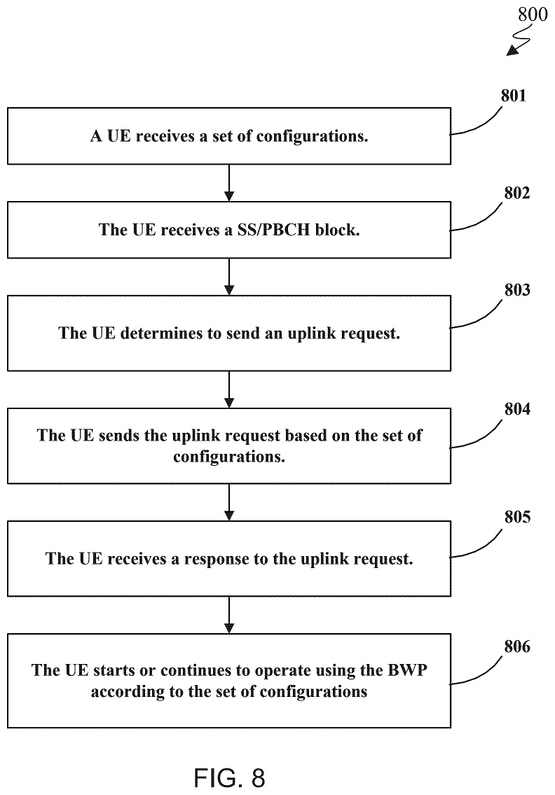

FIG. 8 illustrates an example method 800 performed by a UE with reduced capability to use a separate BWP according to embodiments of the present disclosure. The method 800 may be performed by any of the UEs 111-116 of FIG. 1, such as the UE 116 of FIG. 3, and a corresponding method can be performed by any of the BSs 101-103 of FIG. 1, such as BS 102 of FIG. 2. The method 800 is for illustration only and other embodiments can be used without departing from the scope of the present disclosure.

As shown in FIG. 8, the method 800 begins with the UE receiving a set of configurations (801). The UE then receives a SS/PBCH block (802). The UE then determines to send an uplink request (803). The UE then sends the uplink request based on the set of configurations (804). The UE then receives a response to the uplink request (805). The UE then starts or continues to operate using the BWP according to the set of configurations (806).

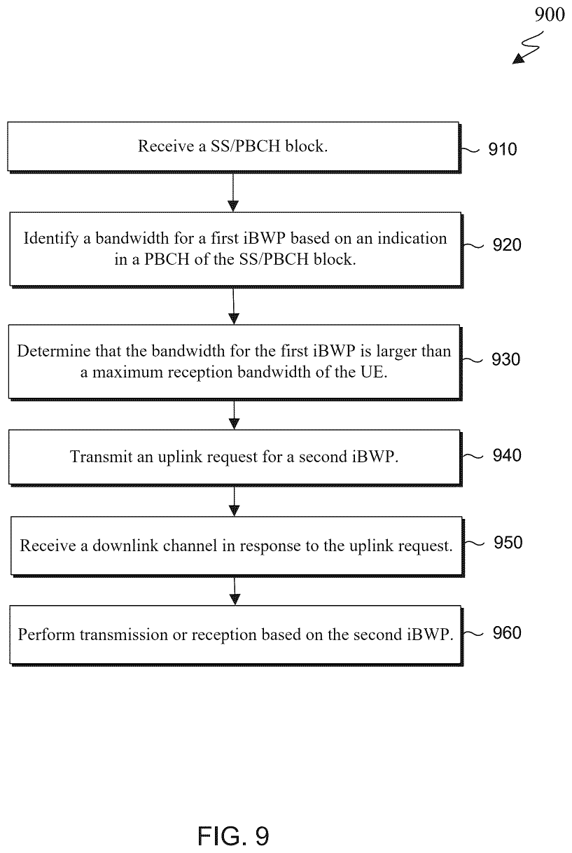

FIG. 9 illustrates a method 900 performed by a UE in a wireless communication system according to embodiments of the present disclosure. The method 900 may be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method begins with the UE receiving a SS/PBCH block (910). The UE then identifies a bandwidth for a first iBWP based on an indication in a PBCH of the SS/PBCH block (920). In various embodiments, the UE determines a measurement result based on the SS/PBCH block and the measurement result is larger than a threshold.

The UE then determines that the bandwidth for the first iBWP is larger than a maximum reception bandwidth of the UE (930). The UE then transmits an uplink request for a second iBWP (940). In various embodiments, configurations for the uplink request are provided by system information of a cell not associated with the SS/PBCH block. In various embodiments, the uplink request is based on a PRACH. In various embodiments, the transmission of the uplink request is based on the second iBWP.

The UE then receives a downlink channel in response to the uplink request (950). In various embodiments, the reception of the downlink channel in response to the uplink request is based on the second iBWP. The UE then performs transmission or reception based on the second iBWP (960). In various embodiments, configurations for the second iBWP are provided by system information of a cell not associated with the SS/PBCH block.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a synchronization signals and physical broadcast channel (SS/PBCH) block; and
a processor operably coupled to the transceiver, the processor configured to:
identify a bandwidth for a first initial bandwidth part (iBWP) based on an indication in a physical broadcast channel (PBCH) of the SS/PBCH block; and
determine that the bandwidth for the first iBWP is larger than a maximum reception bandwidth of the UE,
wherein the transceiver is further configured to:
transmit an uplink request for a second iBWP;
receive a downlink channel in response to the uplink request; and
perform transmission or reception based on the second iBWP.

2. The UE of claim 1, wherein configurations for the uplink request are provided by system information of a cell not associated with the SS/PBCH block.

3. The UE of claim 1, wherein the uplink request is based on a physical random access channel (PRACH).

4. The UE of claim 1, wherein configurations for the second iBWP are provided by system information of a cell not associated with the SS/PBCH block.

5. The UE of claim 1, wherein:
the processor is further configured to determine a measurement result based on the SS/PBCH block, and
the measurement result is larger than a threshold.

6. The UE of claim 1, wherein the transmission of the uplink request is based on the second iBWP.

7. The UE of claim 1, wherein the reception of the downlink channel in response to the uplink request is based on the second iBWP.

8. A base station (BS) in a wireless communication system, the BS comprising:
a processor configured to determine a first initial bandwidth part (iBWP) and a second iBWP, wherein a bandwidth for the second iBWP is smaller than a bandwidth of the first iBWP; and
a transceiver operably coupled to the processor, the transceiver configured to:
transmit a synchronization signals and physical broadcast channel (SS/PBCH) block, wherein a physical broadcast channel (PBCH) of the SS/PBCH block includes an indication of the bandwidth for the first iBWP;
receive an uplink request for the second iBWP;
transmit a downlink channel in response to the uplink request; and
perform transmission or reception based on the second iBWP.

9. The BS of claim 8, wherein configurations for the uplink request are provided by system information of a cell not associated with the SS/PBCH block.

10. The BS of claim 8, wherein the uplink request is based on a physical random access channel (PRACH).

11. The BS of claim 8, wherein configurations for the second iBWP are provided by system information of a cell not associated with the SS/PBCH block.

12. The BS of claim 8, wherein the reception of the uplink request is based on the second iBWP.

13. The BS of claim 8, wherein the transmission of the downlink channel in response to the uplink request is based on the second iBWP.

14. A method of a user equipment (UE) in a wireless communication system, the method comprising:
receiving a synchronization signals and physical broadcast channel (SS/PBCH) block;
identifying a bandwidth for a first initial bandwidth part (iBWP) based on an indication in a physical broadcast channel (PBCH) of the SS/PBCH block;
determining that the bandwidth for the first iBWP is larger than a maximum reception bandwidth of the UE;
transmitting an uplink request for a second iBWP;
receiving a downlink channel in response to the uplink request; and
performing transmission or reception based on the second iBWP.

15. The method of claim 14, wherein configurations for the uplink request are provided by system information of a cell not associated with the SS/PBCH block.

16. The method of claim 14, wherein the uplink request is based on a physical random access channel (PRACH).

17. The method of claim 14, wherein configurations for the second iBWP are provided by system information of a cell not associated with the SS/PBCH block.

18. The method of claim 14, further comprising determining a measurement result based on the SS/PBCH block, wherein the measurement result is larger than a threshold.

19. The method of claim 14, wherein the transmission of the uplink request is based on the second iBWP.

20. The method of claim 14, wherein the reception of the downlink channel in response to the uplink request is based on the second iBWP.
